(19) United States
(12) Patent Application Publication
(10) Pub. No.: US 2023/0072908 A1
(43) Pub. Date: Mar. 9, 2023

(54) Rigidly Bonded Metal Supported Electro-Chemical Stack

(71) Applicant: Hansong Huang, Pleasanton, CA (US)

(72) Inventor: Hansong Huang, Pleasanton, CA (US)

(21) Appl. No.: 17/861,232

(22) Filed: Jul. 10, 2022

Related U.S. Application Data
(60) Provisional application No. 63/237,754, filed on Aug. 27, 2021.

(51) Int. Cl. H01M 8/1226; H01M 8/1246; H01M 4/86; H01M 8/04089; H01M 8/028; H01M 8/2404; H01M 8/2432; H01M 4/88; H01M 8/026

(52) U.S. Cl. CPC H01M 8/1226; H01M 8/1246; H01M 4/8621; H01M 8/04089; H01M 8/028; H01M 8/2404; H01M 8/2432; H01M 4/8825; H01M 8/026; H01M 2008/1293

(57) ABSTRACT

A design of and the process for forming a rigidly bonded metal supported electro-chemical device stack is provided. The electro-chemical device stack can be a solid oxide fuel cell or solid oxide electrolysis stack. The stack comprises multiple planar cells connected in serial by planar metal interconnects. The cells have metal support layers on both anode and cathode sides. The interconnect has gas channels embedded. Thin ceramic electro-chemical active electrodes and electrolyte are sandwiched between the metal support layers. The cells and interconnects are rigidly bonded to form a rigid body stack. The process comprises the steps of a). forming metal supported electro-chemical device cells with metal supports on both anode and cathode sides, b). sealing the peripherals of porous cell layers with an electrically insulating sealing material such as glass. c). bonding the cells and interconnects through commonly used metal-to-metal bonding methods, such as brazing or laser welding.

### CROSS-REFERENCE TO RELATED APPLICATIONS

I hereby claim benefit under Title 35, United States Code, Section 119(e) of U.S. provisional patent application Ser. No. 63/237,754, filed on Aug. 27, 2021. The 63/237,754 application is currently pending. The 63/237,754 application is hereby incorporated by reference into this application.

### BACKGROUND OF THE INVENTION

An electro-chemical device, such as solid oxide fuel cell or solid oxide electrolysis cell, converts between chemical energy and electrical energy. Specifically, a solid oxide fuel cell (SOFC) is an electro-chemical device that converts chemical energy directly to electrical energy through oxidation of a fuel gas. The device is generally composed of ceramics, using an oxygen ion conducting metal oxide derived ceramics as the electrolyte. The electrolyte should be solid, non-porous, or only having closed porosity. Most oxygen ion conducting metal oxides only demonstrate sufficient ion conductivity at elevated temperatures above of 500° C. for ceria based or 600° C. for zirconia based materials. Under differential oxygen partial pressure between the two sides of electrolyte, oxygen ions are transported from cathode to the anode to oxide fuel in anode, generating electrical potential in the process.

Solid oxide fuel cells are advantageous to other fuel cell varieties in having high efficiency and can use other fuel sources in addition to hydrogen, such as natural gas, propane, methanol, kerosene, and diesel, among others, because SOFCs operate at sufficiently high temperature to allow for internal fuel reformation. When operate under hydrogen fuel, unlike proton-exchanged membrane fuel cells, SOFCs do not require high purity hydrogen. In fact, natural gas reformate gas can be directly used as fuel.

A SOFC cell includes a cathode where oxygen is reduced, an electrolyte through which oxygen ions are transported, and an anode where fuel is oxidized. The electrodes must be composed of materials or composites of materials that are a). capable of catalyzing the electro-chemical reactions, b). conducting electrons and oxygen ions, c). stable in oxidizing (in cathode) and reducing (in anode) environments, d). porous so that gas can permeate through, e). mechanically compatible with electrolyte in term of such as thermal expansion and re-oxidization (in anode) dimensional stability, and f). sufficiently rigid and strong as structural support. Furthermore, the multi-layer structure has to be compatible with ceramic fabrication techniques, and ideally conventional methods such as tape-casting, screen-printing, standard sintering process to keep the cost low. The complexity of selecting materials and designs that can meet the matrices of electro-chemical, mechanical, fabrication, and economical constraints are well documented in the literatures.

Solid oxide fuel cells may be manufactured in several forms. Planar designs are commonly used for high space efficiency and low manufacturing cost. A metal supported planar SOFC cell generally has a stainless-steel support layer of 0.1-1 mm thick, upon which thin anode, electrolyte, and cathode layers are deposited by different fabrication processes. A variety of material combinations and fabrication processes can be employed. For example, the electrolyte is formed with yttria-stabilized zirconia (YSZ), sandwiched between a cathode, such as lanthanum strontium manganate (LSM) and YSZ composite, and an anode, such as nickel and YSZ composite. To reduce the ionic resistance, electrolyte should have minimal thickness, such as less than 10 μm when tape-casted or screen-printed. Smaller thickness can be achieved with more expensive techniques. Electrolyte should be non-porous or without open porosity to prevent gas cross-leak. The electrodes should have sufficient porosity to allow gas diffusion and provide sufficient triple phase boundary sites facilitating the chemical reactions. With the metal support layers providing structural support, the electrode thickness can be minimized, such as 20-100 μm, to reduce electrical resistance.

Since an SOFC cell typically provides an electrical potential of approximately 1.1 volts, practical application of SOFC may be arranged in stacks composed of many cells with interconnects joining and conducting current between immediately adjacent cells' cathode and anode. Generally, the interconnects are formed with high temperature alloy metals that are mechanically assembled with sintered cells. Fuel and air are delivered to cell anode and cathode sides respectively, through either gas channels embedded in interconnect, or metallic mesh layer between interconnect and cell. A typical stack structure is shown in FIG. 1. Besides the cells and interconnects, a stack requires: a). anode and cathode frames to support and separate cell and interconnect and provide gas channels, b). sealing layers between cell and interconnect that become viscous at operation temperature to prevent gas leakage and accommodate differential thermal deformation between component layers, c). compliant conductive layers, such as metallic mesh, for electrical contact between cell and interconnect. For maintaining gas sealing and good electrical conduction throughout the assembled stack, the cells, interconnects, and other components are generally required to have high geometrical tolerance, especially in flatness; and the assembled stack is placed under permanent compressive loading. The compressive loading is applied through thick end plates bolted together, made from high temperature creep resistance special alloy. Still, metals have low yielding stress and creep resistance at typical SOFC operation temperatures. The various metallic components of the stack will deform over time, causing sealing failure or loss of electrical contact.

Oxidization resistant ferritic stainless steels have been proposed as structural supports for SOFC and to serve as current collectors. Metal supported SOFC cells allow the ceramic layers to be tailored solely for electro-chemical functions. Because of the need to limit the oxidization of stainless steel at high temperature, the metal supported SOFCs typically operate at intermediate temperatures, such as below 700° C. or as low as 550° C.

In some examples, thin electro-chemical active electrode and electrolyte layers are deposited to prefabricated perforated stainless-steel sheets, forming asymmetrically structured metal supported cells.

The metal supported cells alleviate several challenges faced by conventional ceramic anode supported cell such as redox instability, high electrode electrical resistance, and some fabrication constraints. However, they are assembled into stack similarly to ceramic cells, whereas facing the same challenges. Specifically, the difficulties include: 1). production of flat cells for assembly into stack, and keeping cell flat during operation, 2). maintaining good electrical contact between interconnect and cell, 3). glass seal between layers prone to cracking under thermal cycle due to differential thermal expansions, 4). Thick structural support layer increasing gas diffusion resistance. 5). The metallic interconnect and cell metal supports are exposed in air, inevitably developing oxide scale on its exposed surfaces that increases contact electrical resistance. These mechanisms can cause cells generating 30-50% less power when integrated into a stack. In these aspects, metal supported SOFC cells do not differ from conventional ceramic cells, limiting the potential benefits in final products.

A further improvements of metal supported cell is in the form of symmetric metal supported cell. The metal support layers are formed in both sides of electrodes, specifically metal supports are formed in both cathode and anode sides. More specifically, the cell structure can be symmetric in term of material composition and geometrical thickness in both the active ceramic layers and metal support layers on both anode and cathode side. Consequently, the cells remain flat after fabrication process, which is one of main difficulties in conventional non-symmetric structured cells when assembled into a stack, requiring excessive compression loading to flatten the cell and establish electrical contact between layers. In such symmetric cells, catalytical ingredients can be infiltrated into cells after firing, resulting thin sub-micron thickness electro-chemically active material layers on the electrode backbones and hence activate the cell, but without altering the geometry and mechanical properties of the cells.

The symmetric and flat structure of the cells renders the stack assembly more robust, and less compression loading is required as no flattening of cells is needed. Nevertheless, the problem of losing physical contact between layers, and the increase of electrical resistance due to oxidization of exposed metallic surfaces are problematic and cause performance degradations. The glass sealing between interconnects and cells are still prone to cracking during thermal cycle. To maintain layer-to-layer physical contact and glass sealing, the compressive loading is still required over the stack.

In the present invention, a simple SOFC stack design leveraging the symmetric metal supported cell structure is disclosed. A SOFC stack is fabricated by first forming active symmetric metal supported cells, and metallic interconnects of the same material as the cell's metal supports. The cell and interconnects are connected together through common metal-to-metal bonding method such as brazing or laser welding. The bonding regions also from hermetic seals around gas passages preventing inter-component leakage. The porous peripheral edges of metal supported cells are sealed by an electrically insulating material such as glass.

### SUMMARY OF THE INVENTION

The present invention is directed to the design of and process for forming a rigidly bonded metal supported electro-chemical device stack, specifically a solid oxide fuel cell stack. A stack, such as the example in FIG. 2, includes multiple repeating cells (402) stacked in serial separated by, and rigidly bonded with, interconnects (403), whereas an interconnect is sandwiched between a first cell's anode and its neighboring cell's cathode. The top and bottom surfaces of the stack are bonded with end interconnects (401) and end plates (404) preventing gas leakage from porous layers in the underlying cells.

Each cell comprises an anode metal support (502), a ceramic anode (503) overlying the anode metal support, a ceramic electrolyte (504) overlying the anode, a ceramic cathode (505) overlying the electrolyte, and a cathode metal support (506) overlying the cathode. The second and all other cells comprise the same structure. Cell components are first formed as green layers. Green electrode metal support layers and green electrode layers contain pore formers to produce porosity, whereas electrodes are anode and cathode. The green electrode layers are sintered into porous backbone structures, the anode scaffold and cathode scaffold, into which catalysts are infiltrated to form functional anode and cathode.

The electrode metal support is composed of ferritic stainless steels. The electrolyte and electrode scaffold are composed of oxygen ion conductive metal oxides.

Reference herein to “green” articles is reference to materials that have not undergone sintering. A green article can have suitable strength to support itself and other green layers formed thereon.

Green cells are fired and infiltrated with catalyst precursors into electrode scaffold through porosity in electrode metal support. After the infiltration, the cells are heat-treated to convert precursors to active catalysts. The catalysts being cathode catalyst or anode catalyst. The precursors are metal nitrate solutions of intended stoichiometric composition. For example, an anode catalyst precursor can comprise nickel nitrate, yttrium nitrate, and zirconium nitrate, which after firing are converted to NiO/YSZ catalyst. A cathode precursor can comprise lanthanum nitrate, strontium nitrate, and manganese nitrate, which after firing are converted to LSM catalyst. The catalysts are formed as nano-scale particulate coating on the electrode scaffold pore surfaces.

Electrode scaffold and electrolyte generally are composed of the same material or materials of substantially the same sintering shrinkage and thermal expansion coefficient. Furthermore, electrode metal support and ceramic electrode scaffold are generally composed of materials that have similar sintering shrinkage and thermal expansion coefficient. In some embodiments, the ceramic electrode scaffold and electrolyte material have slightly smaller sintering shrinkage and thermal expansion coefficient than electrode metal support, rendering the ceramic components in compression during sintering to facilitate electrolyte densification, and during post-sintering cool-down and operation to facilitate resistance to stress cracking.

Multiple cells are subsequently bonded with metal interconnects. The bonding surfaces should also form hermetic seals. The metal interconnects are thin stainless sheet plates with gas channels formed. The metal supports and interconnects are of the same or substantially similar materials.

Notably certain characteristics of the green electrolyte, green electrode scaffold material, and green interconnect material, including for example, a combination of morphological characteristics, physical characteristics, and chemical characteristics of the material can be used to facilitate the sintering process having the characteristics described herein. Without wishing to be tied to a particular theory, it is thought that a combination of characteristics, such as particular size distribution of the powder component, packing factor, porosity, chemical composition of each of the layers, thermal expansion properties, and free sintering shrinkage rate, and the like can facilitate a free-sintering process, wherein the cell and entire stack deform substantially uniformly during free-sintering process and post-sintering cool-down.

Several benefits are realized:

a). Cells have substantially symmetric structure to avoid wrappage due to the mismatch of sintering shrinkage and thermal expansion coefficients between metal and ceramic layers.

b). The metal support layers (0.3-5 mm) are substantially thicker than ceramic layers (<0.1 mm). Cell deformation is dominated by the properties of metal layer material, which is the same as or similar to interconnect material, ensuring uniform deformation in stack.

c). Rigid bonding can be formed between metal interconnects and cells. No internal stresses are generated due to uniform deformation, which contrasts with ceramic cells which, if bonded with metal interconnect, are prone to cracking or delamination due to CTE mismatch. Hermetic bonding interfaces eliminate the need for compliant current collection/contact layers, viscous sealing between components, or compression loading.

d). The bonded interface between cell metal supports and interconnect eliminates contact surfaces, providing electrical passages that are protected from being directly exposed to air, reducing or preventing the increases of electrical resistance due to the forming of oxidization layer at contact surfaces.

The formation of stack structure according to embodiment herein facilitates production of sintered and bonded stacks having the desired shape, dimensions, and contours, such as substantially straight edges, flat top and bottom surfaces, flat side walls, requiring little or no post-sintering machining.

To deliver the fuel and air into ceramic electrodes, gas channels are formed in the stack structure.

In some implementation (FIG. 3), gas channels (510) are part of prefabricated interconnect (507). The gas channels can be formed by common techniques such as stamping, machining, milling, assembling sheet metal parts, and other methods known to the person skilled in the art.

The process disclosed in the present invention forms a rigidly bonded electro-chemical device stack, eliminating the need for stack components such as inter-component seals, end compression plate, and others. Stack complexity and cost are significantly reduced. The formed rigid stainless steel structure is exceptionally strong, tough, and robust against external loads such as shock/vibration, thermal shock/thermal cycle, and handling. The stack additionally can withstand internal pressure for using pressurized gas infeed to increase stack operating voltage, power density, and efficiency.

### BRIEF DESCRIPTION OF DRAWINGS

FIG. 1 shows a conventional SOFC stack design prior art using ceramic anode supported cells.

FIG. 2 shows a fully bonded metal supported electro-chemical device stack.

FIG. 3 shows the same stack of FIG. 2 in partially exploded view.

FIG. 4 shows an example of a flow diagram illustrating a fabricating process for a rigidly bonded metal supported electro-chemical device stack.

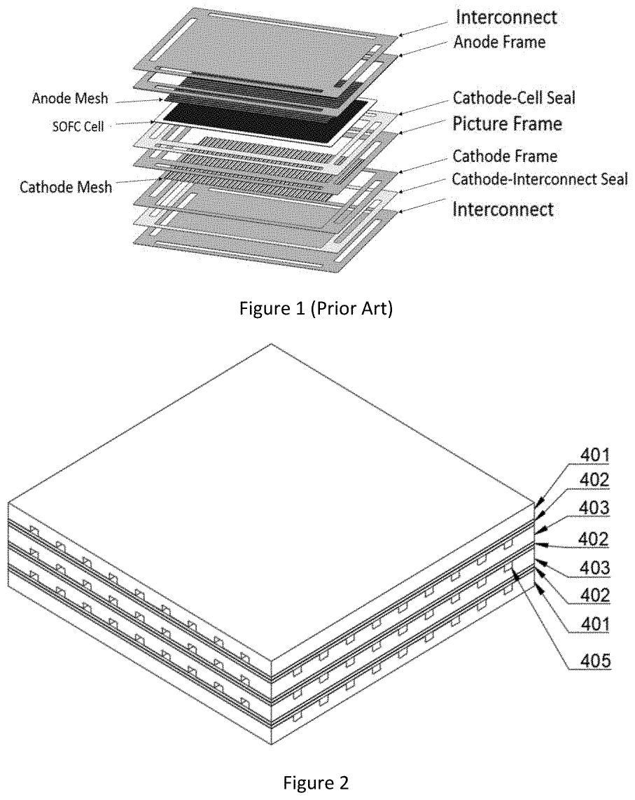

### DETAILED DESCRIPTION OF THE INVENTION

Reference will now be made in detail to some specific details of the invention including the stack design and forming processes. Examples of these specific embodiments are illustrated in the accompanying drawings and descriptions. It will be understood that it is not intended to limit the invention to the described embodiment. On the contrary, it is intended to cover alternatives, modifications and equivalents as may be included within the scope of the inventions as defined by the claims. Particular embodiments of the present invention may be implemented without some of all of the provided details. In other instances, well known processes have not been described in detail in order not to unnecessarily obscure the present invention. The term “about” or “approximate” and like are used to indicate that the value modified by the term has an understood range associated with it, where the range can be ±20%, ±10%, ±5%, or ±1%. The term “substantially” is used to indicate that a value is close to a targeted value, where close can mean the value is within 80%, 85%, 90%, 95%, or 99% of the targeted values.

Typical compositions used in electro-chemical devices such as solid oxide fuel cell or solid oxide electrolysis cell are represented by their commonly used symbols. Some examples are: YSZ— yttria-stabilized zirconia, typically 8 mol % Y (8YSZ), ScSZ-scandia stabilized zirconia, typically 10 mol % Sc, can also contain 1% Ce (10ScSZ, 10Sc1CeSZ), SDC— samaria-dopped ceria, typically 20 mol % Sm, GDC— gadolinium-dopped ceria, typically 20 mol % Gd. LSM —lanthanum strontium manganite, typically 20 mol % La. LSC—lanthanum strontium cobaltite, typically 20% La. LSCF—lanthanum strontium cobalt ferrite, typically 60 mol % La and 20 mol % Co.

In some embodiments, a SOFC stack described in the present invention has gas channel embedded in interconnects (FIG. 2). Multiple cells (402) are connected in serial by, and bonded with, interconnects (403). End interconnects (401) are bonded to the top and bottom surfaces.

Each of the cells has an anode metal support, an anode over the anode metal support, an electrolyte over the anode, a cathode over the electrolyte, a cathode metal support over the cathode. The components described according to the embodiments herein are flat layers parallel to each other. The layers can be formed through techniques including, but not limited to, casting, deposition, printing, extruding, laminations, die-pressing, gel casting, spray coating, screen printing, roll compaction, 3D printing, and a combination thereof. In one embodiment, each of the layers can be formed via screen printing. In another embodiment, each of the layers can be formed via tape casting. In another embodiment, each of the layers can be formed via extrusion.

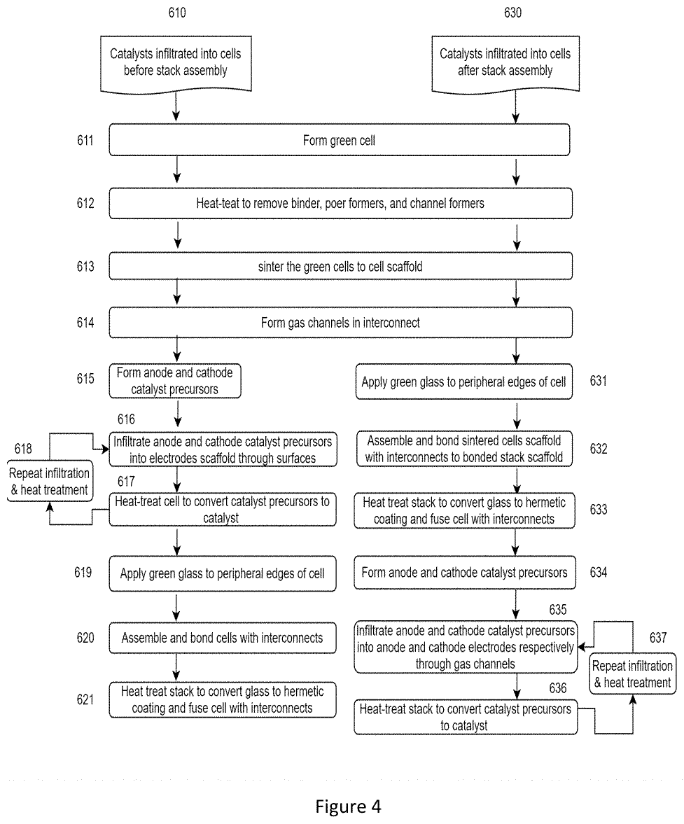

An electro-chemical device stack can be formed through the following steps (FIG. 4):

In some embodiments, the electro-chemically active catalysts are infiltrated into individual cells before the cells are assembled into a stack (610). The individually infiltrated cells facilitate easy quality control and inspection at individual cell level before assembly, at the cost of slow production throughput.

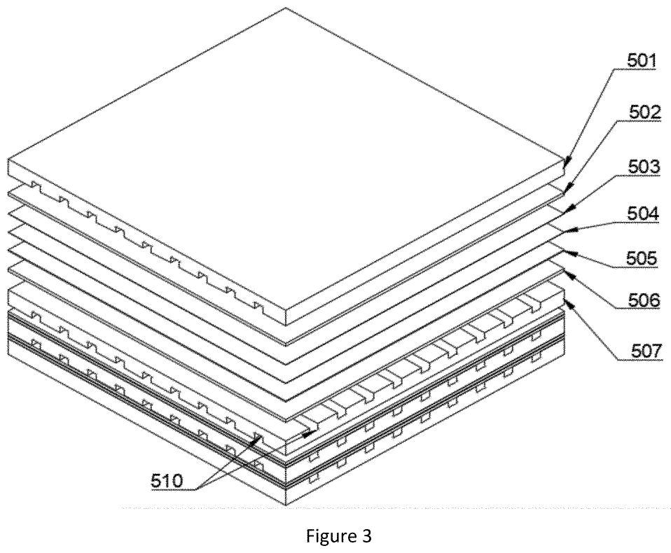

At block (611), form a green cell, comprising: a). forming green anode and cathode metal support layers with binder and pore formers (10-100 μm average size), with post sinter thickness 0.2-5 mm. b). form green anode and cathode layers with binder and pore former (1-20 μm average size), with post sinter thickness of 10-100 μm. c). form green electrolyte layer with the same material or materials of substantially the same sintering shrinkage and thermal expansion coefficient as the electrode layer but without pore formers, with post sinter thickness 5-50 μm. d). laminate layers in the sequence (FIG. 3) of anode metal support layer (502), anode layer (503), electrolyte layer (504), cathode layer (505), and cathode metal support layer (506), to form a green cell. The electrode metal support material can be selected from suitable ferritic stainless steel powders with matching CTE, such as 441, 434, 430, and others. The electrolyte and electrode material can be selected from suitable oxygen iron conductive metal oxide powders such as YSZ, SDC, GDC, ScSZ, ScCeSZ, and others.

After removing binder by heat treatment at block (612), at block (613), individual green cells are sintered to cell scaffolds. Sintering is performed in vacuum or reducing atmospheric environment that are consistent with stainless steel powder metallurgy known to the person skill in the art. The “scaffold” herein is reference to cell or stack structure having porous electrode backbones, electrode being anode and cathode, but without active catalysts. For example, in one embodiment, sintering is performed in 5% H₂/95% Ar gas, at 1200° C., for 2 hours. Sintered electrolyte should be non-porous or without open porosity. Sintered electrode metal support and electrode scaffolds generally have a high volume of porosity to allow diffusion of gaseous species. According to one embodiment, the percent porosity of the formed electrode metal support is not less than 20-50%. According to another embodiment, the percent porosity of the formed electrodes is not less than 10-30%.

The absence of catalytic materials, such as LSM or Ni, in the current step of fabrication allows for higher sintering temperature without adverse effects, such as diffusion of Mn into YSZ, or inter-diffusion between Ni, Fe, and Cr, that often are constraints in other SOFC processing methods. The sintering conditions can be specifically designed to be suitable for fully densifying electrolyte.

At block (614), gas channels are formed in metal interconnect plate. Gas channels can be fabricated by techniques such as stamping, machining, laser cutting, and others, that are known to the person skilled in the art.

At block (615), a cathode catalyst precursor and an anode catalyst precursor are provided. In some embodiments, the catalyst precursor each comprises metal nitrates, a surfactant, and a solvent. For example, in some embodiments, a cathode catalyst precursor comprises lanthanum nitrate, strontium nitrate, and manganese nitrate in stoichiometric composition ratio for converting to La_{0.8}Sr_{0.2}MnO_{3-δ} catalyst after heat treatment. In another example, in some embodiments, an anode catalyst precursor comprises samarium nitrate, cerium nitrate, and nickel nitrate in stoichiometric composition for converting to Sm_{0.2}Ce_{0.8}O_{1.9}/Ni catalyst after heat treatment. Generally, the nitrates should be dissolved close to the maximum solubility to deliver the most catalyst precursor content in each infiltration. The resulted solutions generally have 1-4 mol/L of catalyst concentration.

At block (616), anode catalyst precursors are infiltrated into anode scaffold. Cathode catalyst precursors are infiltrated into cathode scaffold. In some embodiments, areas of cell that are not intended to be infiltrated, such as the edges, are protected with a mask such as polymer-based paint or plastic film before infiltration. The masks will be burned away during heat treatment. In some embodiment, a vacuum pressure can be applied before or during the infiltration process to remove air and facilitate precursor solutions penetration into pores.

At block (617), the catalyst infiltrated stack is heated to about 500° C. to 1000° to convert precursors to nano-particulate catalyst coating on the pore walls of electrode scaffold, converting the cell scaffold to an electro-chemical active SOFC cell. The heat treatment is performed for about 30 minutes to 5 hours. The catalysts in anode and cathode should provide at least one of an electronic conduction pathway, an ionic conduction pathway, and catalytic surfaces, and typically provide all three. In some embodiments the cathode catalyst is selected from a group consisting of lanthanum strontium manganite (LSM), lanthanum strontium cobaltite (LSC), lanthanum strontium ferrite (LSF), samarium strontium cobaltite (SSC), lanthanum strontium cobalt ferrite (LSCF), barium strontium cobalt ferrite (BSCF), samarium strontium cobaltate (SSC), praseodymium nickel oxide (PNO), praseodymium oxide (POx), samarium doped ceria (SDC), gadolinium doped zirconia (GDC), yttria-dopped zirconia (YSZ), and mixtures thereof. In some embodiments, the anode catalyst is selected from a group consisting of nickel strontium titanate, lanthanum strontium titanate, yttrium strontium titanate, niobium titanate, strontium manganese magnesium oxide, nickel and samaria or yttria doped ceria, and mixtures thereof. In some embodiments, composite catalysts can be desirable, recognizing that certain constituent may contribute to one of electronic conductivity, ionic conductivity, and electrocatalysis functions. For example, in one embodiment, an anode catalyst comprises YSZ and Ni. In another embodiment a cathode catalyst comprises LSM and YSZ. In one embodiment, additional Ni is infiltrated to enhance reforming catalytic capability for complex fuels such as natural gas, ammonia, kerosene, methane, propane, ethanol, methanol, propanol and mixtures thereof.

At block (618), the filtration and heat treatment procedures can be repeated several times until the among of catalysts infiltrated into electrode layers reaching specific targets, such as 20 vol %. In some embodiments, the infiltration and heat treatment are repeated 1-10 times for anode catalyst. In some embodiments, the infiltration and heat treatment are repeated 1-10 times for cathode catalyst. In some embodiments, the formed particles remain smaller than about 50-500 nm. After each heat treatment, excess catalysts are removed from the exterior surfaces to reduce potential impact on electro-chemical performance and allow for good gas transportation into porous layers. For example, this can be done by blowing compressed air on the exterior surfaces.

At block (619), coat the metal supported cell peripheral edges with green ceramic, glass, or glass ceramic layer by any suitable techniques known in the art. Such as, for example, dip-coating, spray-coating, roller-coating. The coating material should have a thermal expansion coefficient that is substantially similar as, or slightly smaller than, the CTE of electrode metal support material. The coating material in the present invention can remain rigid in SOFC operation temperatures. The choices of material and the process condition would be known to the person skilled in the art.

At block (620), individual cells are assembled and bonded with interconnects into a fully bonded stack. Multiple cells and interconnects are assembled in serial arrangement whereas interconnect is sandwiched between a cell's anode and the neighboring cell's cathode side. Additional interconnects and end plates are placed on the top and bottom surfaces of the stack structure forming hermetic surfaces. In some embodiment, cells' electrode metal supports and interconnects are bonded by brazing. In some embodiments, cells' electrode metal supports and interconnects are bonded by laser welding. Other metal to metal bonding methods can also be utilized. The bonding should form hermetic sealing around edges, internal manifolds, and other possible gas passages to prevent fuel or air leakage or inter-species mixing.

At block (621), the stack is heat-treated to an appropriate temperature to convert the cell edge coating layer to hermetic seals. In some embodiment, the heat-treatment of cell edge coating layer can be combined with brazing bonding of cells with interconnects in the same process.

In some embodiments, the electro-chemically active catalysts are infiltrated into individual cells after cells are assembled into stack (630). The infiltration into an entire stack improves the production throughput by infiltrating multiple cells at the same time. However, this method renders it not possible to test individual cells before assembly and one defective cell would result in the scrap of the entire stack. The procedure is similar to what has been described in procedure (610), hence, only outlines are described below with major difference emphasized.

Green cells are first formed (611), heat-treated for binder removal (612), and sintered to cell scaffold (613). Interconnects with gas channel built-in are prepared (614).

Green coating layer, such as electrically insulating glass or ceramics, is applied to peripheral edges of formed cell scaffolds (631).

At block (632), the cell scaffolds and interconnects are assembled and bonded together. The assembled stack scaffolds is then heat-treated (633) to convert green coating layer to hermetic sealing layer. If brazing is utilized to bond the cell scaffolds and interconnects, its heat-treatment can be combined with the heat-treatment of cell coating layer.

At block (634), a cathode catalyst precursor and an anode catalyst precursor are provided.

At block (635), the anode catalyst precursor is infiltrated into the stack through fuel gas channels. The cathode catalyst precursor is infiltrated into the stack through air gas channels. A vacuum pressure can be employed for the infiltration.

At block (636), the catalyst infiltrated stack is heated to about 500° C. to 1000° to convert precursors to nano-particulate catalyst coating on the pore walls of electrode scaffold, converting the stack scaffold to an electro-chemical active SOFC stack.

At block (637), the filtration and heat treatment procedures can be repeated several times until the among of catalysts infiltrated into electrode layers reaching specific targets.

A SOFC stack fabricated by performing the methods described in FIG. 4 comprises multiple cells in serial arrangement connected by interconnects. The cells and interconnect layers are rigidly bonded forming a fully bonded structure. Each cell comprises an anode metal support, an anode, an electrolyte, a cathode, and a cathode metal support. In some embodiments, the anode and cathode metal support are of substantially same thickness and are about 0.2-5 mm thick, or about 0.5-2 mm thick. In some embodiments, the anode and cathode are of substantially same thickness and are about 10-100 μm thick, or about 20 mm-50 μm thick. In some embodiments, the electrolyte is about 5-50 μm thick, or about 5-20 μm thick. In some embodiments, the interconnect is about 0.1-2 mm thick, or about 0.2-1 mm thick.

The stack further comprises embedded gas channels in interconnects. The peripheral edges of cells are further covered with hermetic seals on the exterior surfaces. Catalysts are infiltrated into porous electrodes through gas channels and porous electrode metal supports.

Because of the cell and interconnects having the same thermal expansion coefficient, they are bonded together to form a rigidly bonded stack without causing thermal stresses. The metal-to-metal bonding interfaces form hermetic sealing between layers and around gas passages to prevent gas leakage and inter-species mixing. The rigidly bonded stack requires no additional sealing between layers, nor compressive loading on the stack to maintain sealing or electrical contacts, which is a major benefit over conventional stack designs.

The examples of the embodiments disclosed are not intended to be limiting. They are related to the design and fabrication of solid oxide fuel cell stacks. The method described, however, are applicable to other solid state electrochemical devices such as solid oxide electrolysis cells and regenerative or reversible fuel cell/electrolysis cells.

The above-disclosed subject matter is to be considered illustrative, and not restrictive, and the appended claims are intended to cover all Such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

In the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately claimed subject matter.

| | | | |
|---|---|---|---|
| U.S. Pat. No. 4,421,787A | A | December 1983 | Ikezawa |
| U.S. Pat. No. 5,922,486 | A | July 1999 | Chiao |
| U.S. Pat. No. 5,993,986 | A | November 1999 | Wallin |
| US20080131723 | A1 | June 2008 | Tucker |
| US20130093129 | A1 | October 2011 | Mohanram |
| US20030078448 | A1 | March 2013 | Tucker |
| U.S. Pat. No. 8,658,328 | B2 | February 2014 | Suda |
| US20150064596 | A1 | March 2015 | Leah |
| U.S. Pat. No. 8,999,601 | B2 | April 2015 | Gottmann |
| U.S. Pat. No. 9,120,683 | B2 | September 2015 | Yamanis |
| U.S. Pat. No. 1,000,8726 | B2 | June 2018 | Leah |
| US20180323443 | A1 | November 2018 | Tucker |
| US20200280088 | A | March 2020 | Selby |
| US20200358122 | A1 | November 2020 | Tucker |

### OTHER PUBLICATIONS

High Temperature Solid Oxide Fuel Cells, S. Singhal, 2003 Development of Metal Supported solid Oxide Fuel Cells for Operation at 500-600C, N. P. Brando, Journal of Fuel Cell Science and Technology, 2004, 1, 61
Operation of Thin-Film Electrolyte Metal-Supported Solid Oxide Fuel Cells in Lightweight and Stationary Stacks: Material and Microstructural Aspects, Materials, 2016, 9, 762

1. A rigidly bonded metal supported electro-chemical device stack comprising:
a). a plurality of cells, each cell including, an anode metal support, a ceramic anode over the anode metal support, a ceramic electrolyte over the anode, a ceramic cathode over the electrolyte, and a cathode metal support over the cathode;
b). the anode and cathode comprise of porous anode scaffold and cathode scaffold, respectively, and electro-chemically active catalyst particulate coating on the scaffold pore surfaces;
c). planer metal interconnects between the cells, bonded to the anode metal support of a first cell and the cathode metal support of a second cell;
d). cells and interconnects are substantially parallel to each other and form a planar stack of cells, stacked one on top of another, bonded with interconnects;
e). a planar metal interconnect bonded to the top surface of the formed stack, and a planar metal interconnect bonded to the bottom surface of the formed stack;
f). an electronically insulating hermetic coating on the peripheral edges of the stack.

2. The stack of claim 1, wherein the anode and cathode metal supports are porous metal layers, preferably ferritic stainless steels, and have porosity between 20% and 50%.

3. The stack of claim 1, wherein the anode and cathode metal supports are of the same material or materials having substantially similar sintering shrinkage and thermal expansion coefficients.

4. The stack of claim 1, wherein anode and cathode metal supports have thicknesses between 0.2 mm and 5 mm, preferably of substantially similar thicknesses.

5. The stack of claim 1, wherein the anode and cathode are porous ceramic layers, and have porosity between 10% and 30%.

6. The stack of claim 1, where the anode scaffold and cathode scaffold are of the same material or materials having substantially similar sintering shrinkage and thermal expansion coefficients.

7. The stack of claim 1, wherein the anode and cathode have thicknesses between 10 μm and 100 μm, preferably of substantially similar thicknesses.

8. The stack of claim 1, wherein the anode metal support, cathode metal support, anode scaffold, and cathode scaffold are of materials having substantially similar sintering shrinkage and thermal expansion coefficients.

9. The stack of claim 1, wherein the electrolyte is non-porous or without open porosity.

10. The stack of claim 1, wherein the electrolyte has thickness between 5 μm and 50 μm.

11. The stack of claim 1, wherein the electrolyte is of the same material or material having substantially similar sintering shrinkage and thermal expansion coefficient as these of anode and cathode scaffolds.

12. The stack of claim 1, wherein the anode scaffold, cathode scaffold, and electrolyte are oxygen ion conductive metal oxides or proton conductive metal oxides.

13. The stack of claim 1, wherein interconnect is metal plate that is non-porous or without open porosity.

14. The stack of claim 1, wherein gas channels are formed within the metal interconnect.

15. The stack of claim 1, wherein the interconnect is of the same material or material having substantially similar thermal expansion coefficient as these of anode and cathode metal supports.

16. The stack of claim 1, wherein the hermetic coating has thickness of not less than 10 μm and not greater than 5 mm.

17. The stack of claim 1, wherein the hermetic coating has a thermal expansion coefficient that is substantially similar as these of anode and cathode metal supports.

18. The stack of claim 1, wherein the hermetic coating material can be either viscous or rigid at operation temperature.

19. The stack of claim 1, wherein the cell and interconnect are hermetically bonded along all exterior gaps between them, preventing gas leakage to outside and inside gas channels.

20. The stack of claim 1, wherein the bonding between cells and interconnects remains rigid at operation temperature.

21. The stack of claim 1, wherein the bonding method and material between cell and interconnect are electrically conductive at operation temperature.

22. A method for forming an electro-chemical device stack comprising first forming cell scaffolds:
a). forming a first green cell, the first green cell having a green anode metal support, a green anode over the anode metal support, a green electrolyte over the anode, a green cathode over the electrolyte, and a green cathode metal support over the cathode;
b). forming a second green cell, the second green cell having a green anode metal support, a green anode over the anode metal support, a green electrolyte over the anode, a green cathode over the electrolyte, and a green cathode metal support over the cathode;
c). forming all other green cells with the same process and structure;
d). free sintering the first, the second, and all other green cells into cell scaffolds.

23. The method of claim 22, wherein forming the green cells comprises tape casting or screen printing of the green anode and cathode metal supports, green anode and cathode scaffolds, and green electrolyte to form green cell scaffolds prior to sintering.

24. The method of claim 22, wherein the green anode and cathode metal supports and green anode and cathode scaffolds are formed with pore formers; the green electrolyte is formed without pore former.

25. The method of claim 22, wherein sintering is performed between 1100° and 1500°, in reducing or vacuum environment.

26. The method of claim 22, wherein sintering is performed for 0.5 hours to 10 hours.

27. A method for forming an electro-chemical device stack of claim 22 further includes infiltrating active catalysts into cell scaffolds:
a. providing a sintered cell scaffold, having porous anode and cathode metal supports, porous anode and cathode scaffolds, and dense electrolyte;
b. providing an anode catalyst precursor and a cathode catalyst precursor;
c. infiltrating the anode catalyst precursor through anode electrode metal support;
d. infiltrating the cathode catalyst precursor through cathode electrode metal support;
e. heating the cell to between 500° C. and 1000° C. for between 10 minutes and 5 hours to convert precursors to catalysts, and henceforth converting cell scaffold to active cell.

28. The method of claim 27, wherein infiltrations are performed in a vacuum between 100-300 mbar.

29. The method of claim 27, wherein operations c), d), and e) are repeated until sufficient amount of the anode catalyst and cathode catalyst are deposited into scaffolds, such as 1-10 times.

30. The method of claim 27, wherein the anode and cathode catalyst precursors comprise metal nitrate solution in sociochemical compositions that are converted to anode and cathode catalysts after heat treatment, respectively.

31. A method for forming an electro-chemical device stack of claim 27 further includes forming a bonded stack:
a. providing catalysts infiltered active cells;
b. providing interconnects, which can be stainless steel plates with gas channels;
c. bonding the first cell with an interconnect, bonding the second cell with the interconnect;
d. repeating b) for all other cells and interconnects to form a bonded stack;
e. coating the cell peripheral edge surfaces with green ceramic, glass, or glass ceramic;
f. firing the formed stack at temperature between 500° and 1000° to convert green coating to hermetic coating;
g. if brazing is utilized to bond cell to interconnect, firing the formed bonded stack at appropriate temperature to form hermetic bonding between cells and interconnects.

32. A method for forming an electro-chemical device stack of claim 22 further includes forming a bonded stack scaffold:
a. providing sintered cell scaffolds, each having porous anode and cathode metal supports, porous anode and cathode scaffolds, and dense electrolyte;
b. providing interconnects, which can be stainless steel plates with gas channels;
c. bonding the first cell scaffold with an interconnect, bonding the second cell scaffold with the interconnect;
d. repeating b) for all other cell scaffolds and interconnects to form a bonded stack scaffold;
e. coating the stack peripheral edge surfaces with green ceramic, glass, or glass ceramic;
f. firing the formed bonded stack at temperature between 500° and 1000° to convert green coating to a hermetic coating;
g. if brazing is utilized to bond cell scaffold to interconnect, firing the formed stack at appropriate temperature to form hermetic bonding layer between cell scaffolds and interconnects.

33. A method for forming an electro-chemical device stack of claim 32 further includes infiltrating active catalysts into the bonded stack scaffold:
a. providing a bonded stack scaffold, having cell scaffolds and interconnects rigidly bonded together;
b. providing an anode catalyst precursor and a cathode catalyst precursor;
c. infiltrating the anode catalyst precursor into anode electrode layers through stack fuel gas channels in interconnects;
d. infiltrating the cathode catalyst precursor through cathode electrode layers through stack air gas channels in interconnects;
e. heating the stack to between 500° C. and 1000° C. for between 10 minutes to 5 hours to convert precursors to catalysts, and henceforth convert stack scaffold to active stack.

34. The method of claim 33, wherein infiltrations are performed in a vacuum between 100-300 mbar.

35. The method of claim 33, wherein operations b), c), and d) are repeated until sufficient amounts of the anode catalyst and cathode catalyst are deposited into electrode scaffolds, such as 1-10 times.

36. The method of claim 33, wherein the anode and cathode catalyst precursors comprise metal nitrate solution in sociochemical compositions that are converted to anode and cathode catalysts after heat treatment, respectively.
